(19) United States
(12) Patent Application Publication
(10) Pub. No.: US 2017/0102032 A1
(43) Pub. Date: Apr. 13, 2017

(54) LOW FRICTION BALL BEARING CAGE DESIGN WITH OPTIMIZED CONTACT SURFACE

(71) Applicant: Schaeffler Technologies AG & Co., KG, Herzogenaurach (DE)

(72) Inventor: Michael HEATON, Rock Hill, SC (US)

(73) Assignee: SCHAEFFLER TECHNOLOGIES AG & CO. KG, Herzogenaurach (DE)

(21) Appl. No.: 14/880,662

(22) Filed: Oct. 12, 2015

(51) Int. Cl. F16C 33/38; F16C 19/18

(52) U.S. Cl. CPC F16C 33/3887; F16C 33/3806; F16C 19/18

(57) ABSTRACT

A cage for a rolling bearing assembly with optimized contact surfaces to reduce friction between the cage and the adjacent contact surfaces is disclosed. The rolling bearing assembly includes a radially inner bearing ring including a radially inner race defined on a radially inner rolling element facing surface, a radially outer bearing ring including a radially outer race defined on a radially outer rolling element facing surface, and a plurality of rolling elements supported to roll between the radially inner race and the radially outer race. The cage includes a first rim including a first rolling element guide surface facing a plurality of rolling elements. A first outer surface facing away from the first rolling element guide surface includes a first outward projection. In another embodiment two bearing assemblies are provided, and each of the bearing assemblies includes a cage with optimized contact surfaces.

### FIELD OF INVENTION

The present invention relates to a bearing assembly, and is more particularly related to a bearing cage for a bearing assembly.

### BACKGROUND

Bearing assemblies are used in a variety of applications, including automotive assemblies. One type of bearing assembly requires a cage to guide rolling elements as the rolling elements roll between a radially inner bearing ring and a radially outer bearing ring. During rotation, the cage can contact one or more adjacent surfaces of the bearing assembly, which causes additional friction or drag. It would be desirable to reduce the friction between the cage and the adjacent surfaces.

### SUMMARY

A cage for a rolling bearing assembly is provided with optimized contact surfaces to reduce friction between the cage and the adjacent contact surfaces. The rolling bearing assembly includes a radially inner bearing ring including a radially inner race defined on a radially inner rolling element facing surface, a radially outer bearing ring including a radially outer race defined on a radially outer rolling element facing surface, and a plurality of rolling elements supported to roll between the radially inner race and the radially outer race. The cage includes a first rim and a plurality of webs extending from the first rim. The plurality of webs define rolling element pockets, and the first rim includes a first rolling element guide surface facing the plurality of rolling elements. A first outer surface facing away from the first rolling element guide surface includes a first outward projection.

In another embodiment two bearing assemblies are provided, and each of the bearing assemblies includes a cage with optimized contact surfaces.

### BRIEF DESCRIPTION OF THE DRAWINGS

The foregoing Summary and the following detailed description will be better understood when read in conjunction with the appended drawings, which illustrate a preferred embodiment of the invention. In the drawings:

FIG. 1 is a cross-sectional view of a rolling bearing assembly according to a first embodiment of the invention.

FIGS. 2A and 2B are perspective views of a cage for the rolling bearing assembly of FIG. 1.

FIG. 3 is a cross-sectional view of the cage of FIGS. 1, 2A, and 2B.

FIGS. 4A and 4B are enlarged section views of FIG. 3.

FIGS. 5A-5D show alternative embodiments of outward projections for a cage in cross-section.

FIG. 6 shows a second embodiment of the rolling bearing assembly in cross-section including two cages.

FIGS. 7A and 7B are perspective views of a first and second cage of the rolling bearing assembly of FIG. 6.

### DETAILED DESCRIPTION OF THE PREFERRED EMBODIMENTS

Certain terminology is used in the following description for convenience only and is not limiting. The words “front,” “rear,” “upper,” and “lower” designate directions in the drawings to which reference is made. The words “inwardly” and “outwardly” refer to directions toward and away from the parts referenced in the drawings. “Axially” refers to a direction along the axis of a shaft or rotating part. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

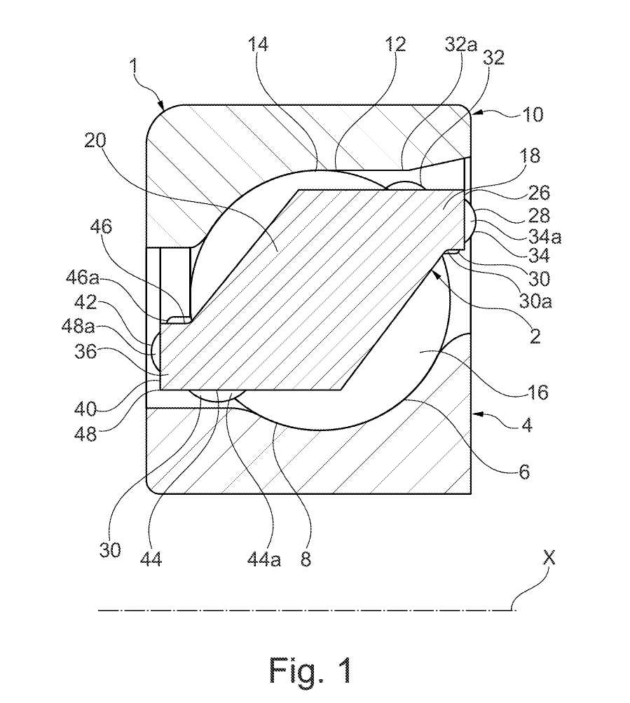

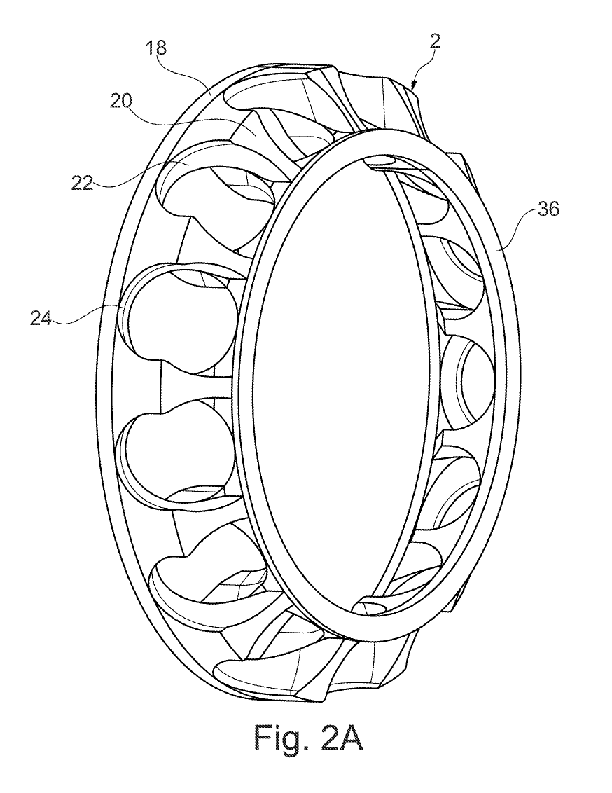

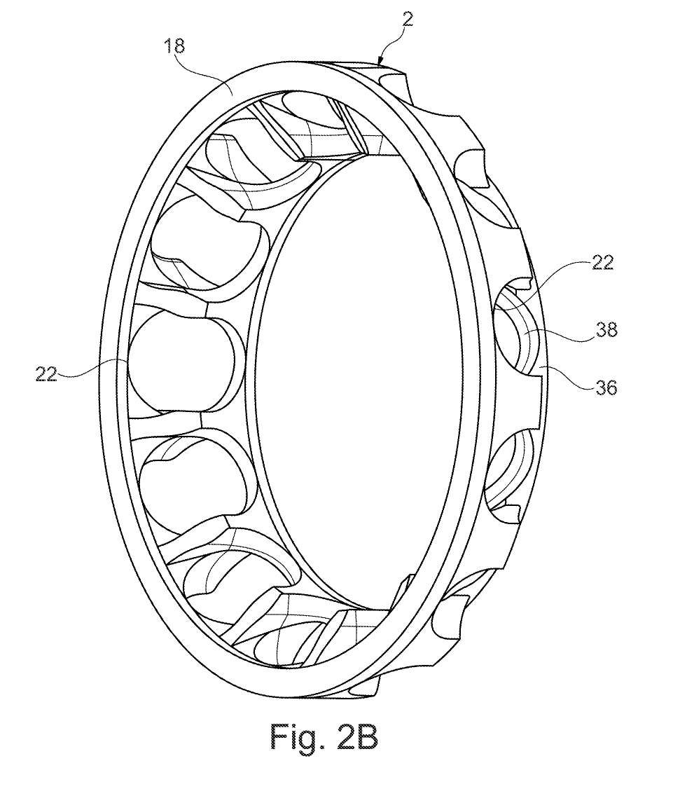

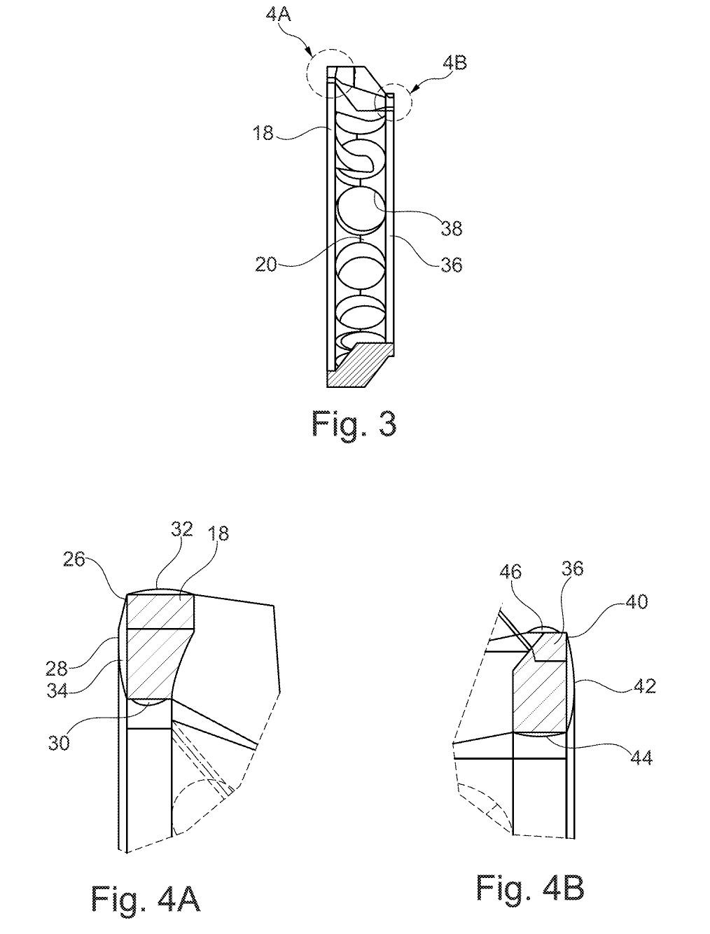

FIGS. 1-3, 4A, and 4B illustrate a cage 2 for a rolling bearing assembly 1 including a feature for reducing friction between the cage 2 and an element adjacent to the cage 2, such as a radially inner bearing ring 4, a radially outer bearing ring 10, an opposing cage, or a housing. The rolling bearing assembly 1 includes a radially inner bearing ring 4 having a radially inner race 6 defined on a radially inner rolling element facing surface 8. A radially outer bearing ring 10 includes a radially outer race 12 defined on a radially outer rolling element facing surface 14. A plurality of rolling elements 16 are supported to roll between the radially inner race 6 and the radially outer race 12. The cage 2 includes a first rim 18 and a plurality of webs 20 extending from the first rim 18. The plurality of webs 20 define rolling element pockets 22, and the first rim 18 includes a first rolling element guide surface 24 facing the plurality of rolling elements 16. A first outer surface 26 located away from the first rolling element guide surface 24 includes a first outward projection 28. This first outward projection 28 provides a point contact, in cross-section, between the cage 2 and an adjacent surface, which significantly reduces friction between the cage 2 and the adjacent surface compared to other configurations in which the cage includes flat contact surfaces.

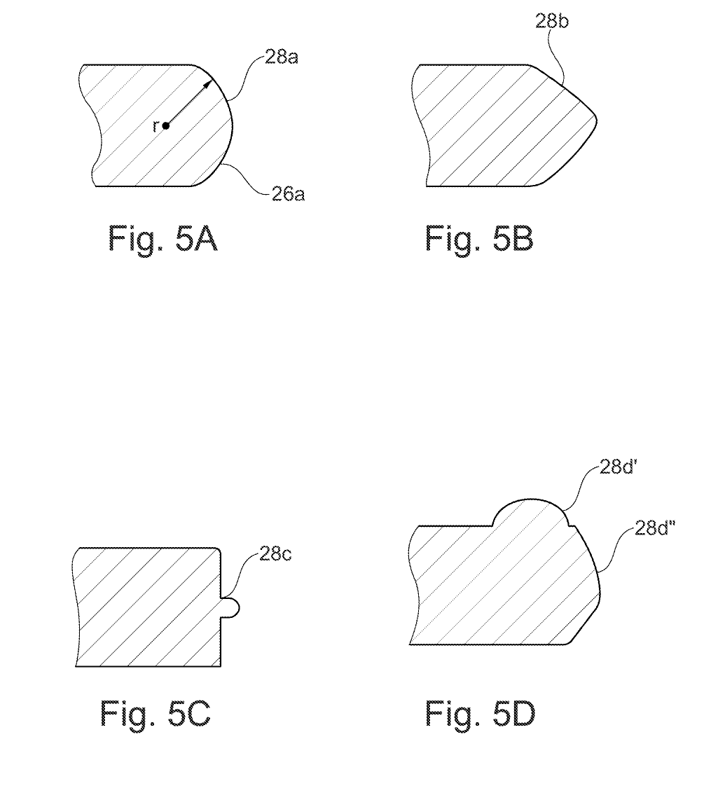

As used in this application, the term “projection” refers to any one of a variety of non-planar shapes or profiles. In a first embodiment of the first outward projection 28a shown in FIG. 5A, the first outward projection 28a includes a convex profile in cross-section. As shown in FIG. 5A, the convex profile of the first outward projection 28a extends along an entire length of the first outer surface 26a. As shown in FIG. 5A, the first outward projection 28a is preferably a radiused surface having a radius of curvature (r). The radius of curvature (r) of the first outward projection 28a can be varied to modify the degree of friction between the first outward projection 28a and an opposing adjacent surface. In a second embodiment of the first outward projection 28b embodiment shown in FIG. 5B, the first outward projection 28b has a triangular profile in cross-section, which preferably terminates in a rounded point. A third embodiment of the first outward projection 28c shown in FIG. 5C includes a localized protuberance or bulge, in cross-section. As shown in FIG. 5C, the protuberance only extends out from a portion of the end surface. In a fourth embodiment of the first outward projection 28d shown in FIG. 5D, the first outward projection 28d includes two radiused profile surfaces 28d′, 28d″. These configurations are provided as examples of the first outward projection 28a-28d, and one of ordinary skill in the art recognizes that other shapes of the projection can be used that provide a point contact in cross-section between the cage 2 and an opposing adjacent surface.

FIG. 1 illustrates the first rim 18 of the cage 2 preferably including (1) a first radially inwardly directed outward projection 30a on a first radially inner surface 30 that faces towards the radially inner rolling element facing surface 8 of the radially inner bearing ring 4, (2) a first radially outwardly directed outward projection 32a on a first radially outer surface 32 that faces towards the radially outer rolling element facing surface 14 of the radially outer bearing ring 10, and (3) a first axially outwardly directed outward projection 34a on a first outer surface 34 that faces away from the first rolling element guide surface 24 of the first rim 18. One of ordinary skill in the art will recognize from the present disclosure that any combination of the first outward projections 30a, 32a, 34a could be used to provide reduced contact surfaces of the first rim 18.

As shown in FIGS. 1-3, 4A, and 4B, the cage 2 includes a second rim 36 and the plurality of webs 20 extend between the first rim 18 and the second rim 36. The second rim 36 includes a second rolling element guide surface 38 facing the plurality of rolling elements 16. A second outer surface 40 is located away from the second rolling element guide surface 38, and the second outer surface 40 includes a second outward projection 42. As shown in FIG. 1, the second rim 36 preferably includes (1) a second radially inwardly directed outward projection 44a on a second radially inner surface 44 that faces towards the radially inner rolling element facing surface 8 of the radially inner bearing ring 4, (2) a second radially outwardly directed outward projection 46a on a second radially outer surface 46 that faces towards the radially outer rolling element facing surface 14 of the radially outer bearing ring 10, and (3) a second axially outwardly directed outward projection 48a on a second outer surface 48 that faces away from the second rolling element guide surface 38 of the second rim 36. One of ordinary skill in the art will recognize from the present disclosure that any combination of the second outward projections 44a, 46a, 48a could be used to provide reduced contact surfaces for the second rim 36. As shown in FIG. 1, the first rim 18 has a larger diameter than the second rim 36. One of ordinary skill will recognize from the present disclosure that the sizes of the first rim 18 and second rim 36 can be varied depending on the particular application.

In a second embodiment of the rolling bearing assembly 100, a double-row tandem rolling bearing assembly is provided. The double-row tandem rolling bearing assembly 100 includes a first rolling bearing assembly 102 and a second rolling bearing assembly 104. The first rolling bearing assembly 102 includes a first radially inner bearing ring 106 including a first radially inner race 108 defined on a first radially inner rolling element facing surface 110. A first radially outer bearing ring 112 includes a first radially outer race 114 defined on a first radially outer rolling element facing surface 116. A first plurality of rolling elements 118 are supported to roll between the first radially inner race 108 and the first radially outer race 114.

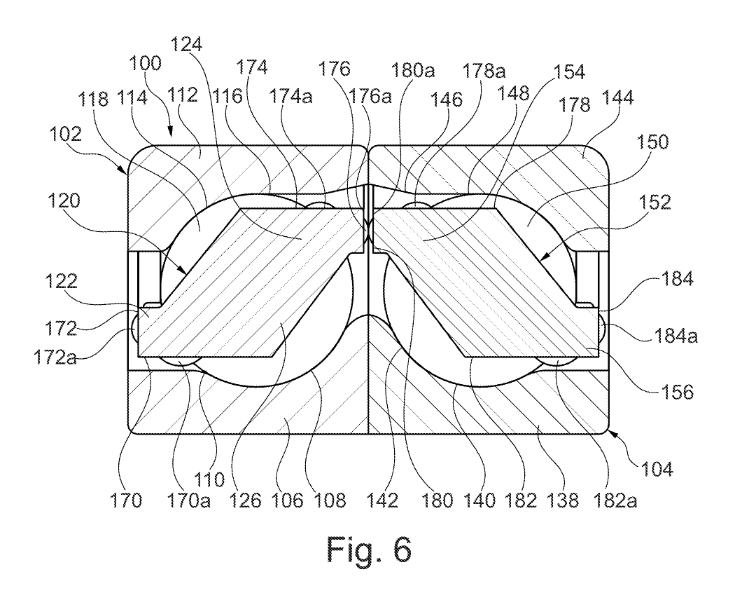

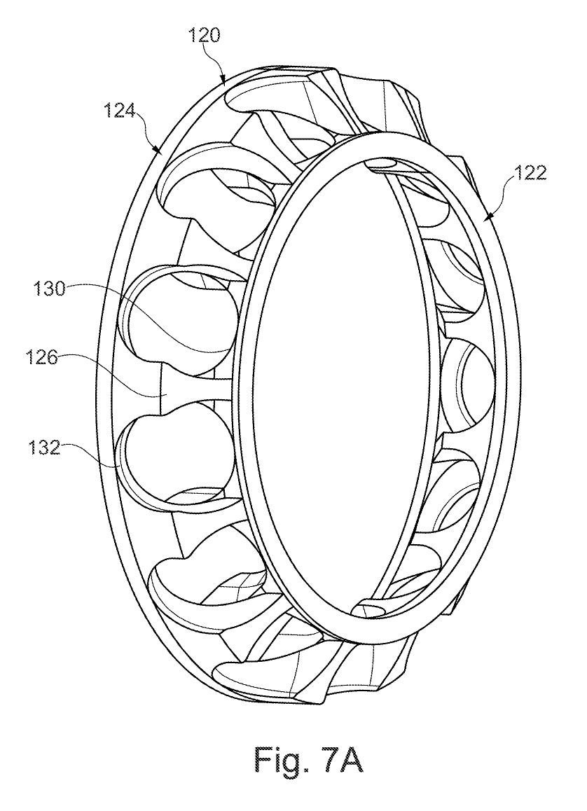

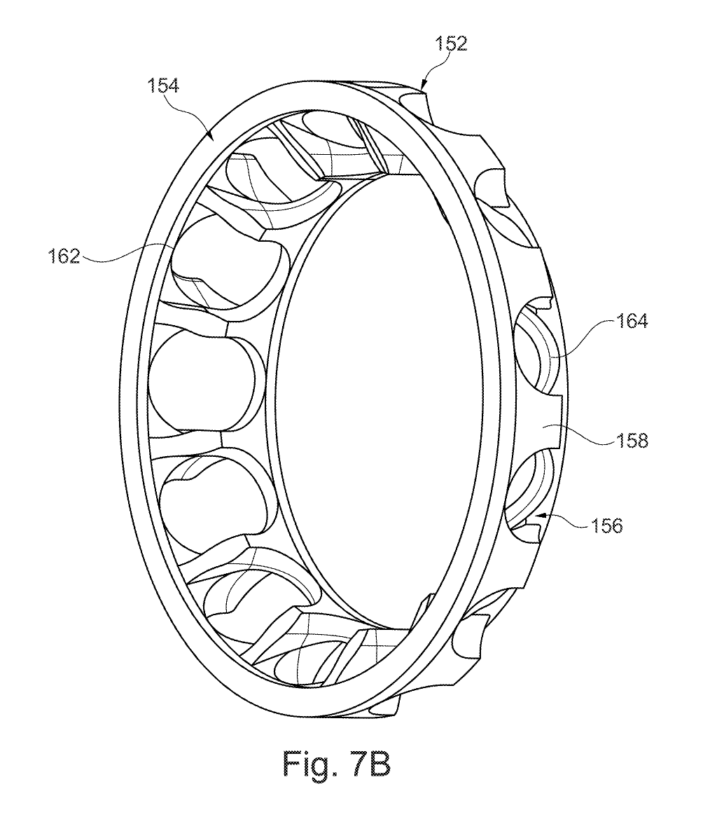

As shown in FIGS. 6 and 7A, a first cage 120 of the first rolling bearing assembly 102 includes a first rim 122 and a second rim 124 with a first plurality of webs 126 extending therebetween. The first plurality of webs 126 define rolling element pockets 128 for the first plurality of rolling elements 118. The first rim 122 includes a first rolling element guide surface 130 facing the first plurality of rolling elements 118 and the second rim 124 includes a second rolling element guide surface 132 facing the first plurality of rolling elements 118. The first rim 122 or the second rim 124 each include outer surfaces facing away from the first rolling element guide surface 130 or the second rolling element guide surface 132, respectively, and at least one of the outer surfaces includes a first outward projection.

In the embodiment of FIG. 6, the first rim 122 includes (1) a first radially inner surface 170 that faces towards the first radially inner rolling element facing surface 110 of the first radially inner bearing ring 106, the first radially inner surface 170 includes a first radially inwardly directed outward projection 170a, and (2) a first outer surface 172 that faces away from the first rolling element guide surface 130 of the first rim 122 includes a first axially outwardly directed outward projection 172a.

In the embodiment of FIG. 6, the second rim 124 includes (1) a second radially outer surface 174 that faces towards the first radially outer rolling element facing surface 116 of the first radially outer bearing ring 112, the second radially outer surface 174 includes a second radially outwardly directed outward projection 174a, and (2) a second outer surface 176 that faces away from the second rolling element guide surface 132 of the second rim 124 includes a second outward axially outwardly directed projection 176a.

The second rolling bearing assembly 104 includes a second radially inner bearing ring 138 including a second radially inner race 140 defined on a second radially inner rolling element facing surface 142. A second radially outer bearing ring 144 includes a second radially outer race 146 defined on a second radially outer rolling element facing surface 148. A second plurality of rolling elements 150 are supported to roll between the second radially inner race 140 and the second radially outer race 146. A second cage 152 includes a third rim 154 and a fourth rim 156 with a second plurality of webs 158 extending therebetween, and the second plurality of webs 158 define rolling element pockets 160 for the second plurality of rolling elements 150. The third rim 154 includes a third rolling element guide surface 162 facing the second plurality of rolling elements 150 and the fourth rim 156 includes a fourth rolling element guide surface 164 facing the second plurality of rolling elements 150. The third rim 154 and the fourth rim 156 each include outer surfaces facing away from the third rolling element guide surface 162 or the fourth rolling element guide surface 164, and the second outer surface includes a second outward projection.

In the embodiment shown in FIG. 6, the third rim 154 includes (1) a third radially outer surface 178 that faces towards the second radially outer rolling element facing surface 148 of the second radially outer bearing ring 144, the third radially outer surface 178 includes a third radially outwardly directed outward projection 178a, and (2) a third outer surface 180 that faces away from the third rolling element guide surface 162 of the third rim 154 includes a third axially outwardly directed outward projection 180a. As shown in FIG. 6, the third axially outwardly directed outward projection 180a of the third rim 154 of the second cage 104 faces the second axially outwardly directed outward projection 176a of the second rim 124 of the first cage 102.

In the embodiment shown in FIG. 6, the fourth rim 156 includes (1) a fourth radially inner projecting surface 182 that faces towards the second radially inner rolling element facing surface 142 of the second radially inner bearing ring 138, the fourth radially inner projection surface 182 includes a fourth radially inwardly directed outward projection 182a, and (2) a fourth outer surface 184 that faces away from the fourth rolling element guide surface 164 of the fourth rim 156 includes a fourth axially outwardly directed outward projection 184a.

As described above, all of these outward projections of the cages provide reduced contact areas with adjacent surfaces of the bearing rings, an outside housing, and each other.

Having thus described the present invention in detail, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiment and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

What is claimed is:

1. A rolling bearing assembly comprising:
a radially inner bearing ring including a radially inner race defined on a radially inner rolling element facing surface;
a radially outer bearing ring including a radially outer race defined on a radially outer rolling element facing surface;
a plurality of rolling elements supported to roll between the radially inner race and the radially outer race; and
a cage including a first rim and a plurality of webs extending from the first rim, the plurality of webs defining rolling element pockets, the first rim including a first rolling element guide surface facing the plurality of rolling elements, and a first outer surface facing away from the first rolling element guide surface, the first outer surface including a first outward projection.

2. The rolling bearing assembly of claim 1, wherein the first outward projection has a convex profile.

3. The rolling bearing assembly of claim 2, wherein the convex profile extends along an entire length of the first outer surface.

4. The rolling bearing assembly of claim 1, wherein the first outward projection is formed with a radiused surface.

5. The rolling bearing assembly of claim 1, wherein the first outward projection is located on at least one of:
(1) a first radially inner surface that faces towards the radially inner rolling element facing surface of the radially inner bearing ring,
(2) a first radially outer surface that faces towards the radially outer rolling element facing surface of the radially outer bearing ring, or
(3) a first outer surface that faces away from the first rolling element guide surface of the first rim.

6. The rolling bearing assembly of claim 1, wherein the cage comprises a second rim, the plurality of webs extend between the first rim and the second rim, the second rim includes a second rolling element guide surface facing the plurality of rolling elements, and a second outer surface facing away from the second rolling element guide surface, the second outer surface includes a second outward projection.

7. The rolling bearing assembly of claim 6, wherein the second outward projection is located on at least one of:
(1) a second radially inner surface that faces towards the radially inner rolling element facing surface of the radially inner bearing ring,
(2) a second radially outer surface that faces towards the radially outer rolling element facing surface of the radially outer bearing ring, or
(3) a second outer surface that faces away from the second rolling element guide surface of the second rim.

8. A double-row tandem rolling bearing assembly comprising:
(1) a first rolling bearing assembly including:
a first radially inner bearing ring including a first radially inner race defined on a first radially inner rolling element facing surface;
a first radially outer bearing ring including a first radially outer race defined on a first radially outer rolling element facing surface;
a first plurality of rolling elements supported to roll between the first radially inner race and the first radially outer race; and
a first cage including a first rim and a second rim with a first plurality of webs extending therebetween, the first plurality of webs defining rolling element pockets for the first plurality of rolling elements,
the first rim includes a first rolling element guide surface facing the first plurality of rolling elements and the second rim includes a second rolling element guide surface facing the first plurality of rolling elements,
the first rim and the second rim each include outer surfaces facing away from the first rolling element guide surface or the second rolling element guide surface, respectively, and at least one of the outer surfaces of the first or second rims includes a first outward projection; and
(2) a second rolling bearing assembly including:
a second radially inner bearing ring including a second radially inner race defined on a second radially inner rolling element facing surface;
a second radially outer bearing ring including a second radially outer race defined on a second radially outer rolling element facing surface;
a second plurality of rolling elements supported to roll between the second radially inner race and the second radially outer race; and
a second cage including a third rim and a fourth rim with a second plurality of webs extending therebetween, the second plurality of webs defining rolling element pockets for the second plurality of rolling elements,
the third rim includes a third rolling element guide surface facing the second plurality of rolling elements and the fourth rim includes a fourth rolling element guide surface facing the second plurality of rolling elements, and
the third rim and the fourth rim each include outer surfaces facing away from the third rolling element guide surface or the fourth rolling element guide surface, respectively, and at least one of the outer surfaces of the third or fourth rims includes a second outward projection.

9. The double-row tandem rolling bearing assembly of claim 8, wherein the first rim includes at least two of the outward projections, wherein (1) a first one of the outward projections is located on a first radially inner surface that faces towards the first radially inner rolling element facing surface of the first radially inner bearing ring, and (2) a second one of the outward projections is located on a first outer surface that faces away from the first rolling element guide surface of the first rim.

10. The double-row tandem rolling bearing assembly of claim 8, wherein the second rim includes at least two of the outward projections, wherein (1) a first one of the outward projections is located on a second radially outer surface that faces towards the first radially outer rolling element facing surface of the first radially outer bearing ring, and (2) a second one of the outward projections is located on a second outer surface that faces away from the second rolling element guide surface of the second rim.

11. The double-row tandem rolling bearing assembly of claim 8, wherein the third rim includes at least two of the outward projections, wherein (1) a first one of the outward projections is located on a third radially outer surface that faces towards the second radially outer rolling element facing surface of the second radially outer bearing ring, and (2) a second one of the outward projections is located on a third outer surface that faces away from the third rolling element guide surface of the third rim.

12. The double-row tandem rolling bearing assembly of claim 8, wherein the fourth rim includes at least two of the outward projections, wherein (1) a first one of the outward projections is located on a fourth radially inner projecting surface that faces towards the second radially inner rolling element facing surface of the second radially inner bearing ring, and (2) a second one of the outward projections is located on a fourth outer surface that faces away from the fourth rolling element guide surface of the fourth rim.
